(19) United States
(12) Patent Application Publication
(10) Pub. No.: US 2025/0274867 A1
(43) Pub. Date: Aug. 28, 2025

(54) METHOD AND DEVICE FOR RECEIVING AND TRANSMITTING INFORMATION

(71) Applicant: Samsung Electronics Co., Ltd., Gyeonggi-do (KR)

(72) Inventors: Zhe CHEN, Beijing (CN); Feifei SUN, Beijing (CN); Bin YU, Beijing (CN)

(21) Appl. No.: 18/859,806

(22) PCT Filed: Apr. 27, 2023
(86) PCT No.: PCT/KR2023/005810

§ 371 Date: Oct. 24, 2024

(30) Foreign Application Priority Data
Apr. 27, 2022 (CN) 202210458050.9

(51) Int. Cl. H04W 52/02; H04L 5/00; H04W 24/04; H04W 72/044

(52) U.S. Cl. CPC H04W 52/0235; H04L 5/0094; H04W 24/04; H04W 72/044

(57) ABSTRACT

The disclosure relates to a 5G or 6G communication system for supporting a higher data transmission rate. The disclosure provides a method performed by a user equipment (UE), which comprises: receiving indication information from a base station; and determining whether to monitor a reference signal set related to beam failure based on the indication information. The disclosure also provides a method performed by a user equipment (UE), which comprises receiving indication information from a base station; and determining to monitor a reference signal set corresponding to the indication information based on the indication information, wherein the reference signal set is a first reference signal set or a second reference signal set.

### TECHNICAL FIELD

The disclosure relates generally to wireless communication systems and more particularly to a method and a device for receiving and transmitting information.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called downlink, and transmission from a UE to a base station is called uplink.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

In actual deployment, in order to reduce power consumption, a base station employs a more flexible scheduling method. Currently, a UE cannot adapt to this scheduling method well, for example, the accuracy of beam failure detection will be reduced, hence the reliability of the UE will be reduced. In order to improve the reliability of the UE, it is necessary to propose an improved beam failure detection method.

### Solution to Problem

In an embodiment of the disclosure, a method performed by a user equipment (UE) is proposed, which includes receiving indication information from a base station; and determining whether to monitor a reference signal set related to beam failure based on the indication information.

In an embodiment of the disclosure, determining whether to monitor the reference signal set related to beam failure based on the indication information includes determining whether to monitor the reference signal set related to beam failure on a first time domain resource based on the indication information; wherein the first time domain resource is determined based on at least one of: starting and/or ending of the first time domain resource is determined by the indication information; a time domain position of the first time domain resource is determined by a time domain position of a channel or signal carrying the indication information.

In an embodiment of the disclosure, determining whether to monitor the reference signal set related to beam failure based on the indication information includes determining whether to monitor the reference signal set related to beam failure based on at least one of a serving cell, a bandwidth part, a cell physical layer identity and a transmission and reception point corresponding to the indication information.

In an embodiment of the disclosure, a method performed by a user equipment (UE) is proposed, which includes receiving indication information from a base station; and determining to monitor a reference signal set corresponding the indication information based on the indication information, wherein the reference signal set is a first reference signal set or a second reference signal set.

In an embodiment of the disclosure, determining to monitor the reference signal set corresponding to the indication information based on the indication information includes determining to monitor the reference signal set corresponding to the indication information on a second time domain resource based on the indication information; wherein the second time domain resource is determined based on at least one of: starting and/or ending of the second time domain resource is determined by the indication information; a time domain position of the second time domain resource is determined by a time domain position of a channel or signal carrying the indication information.

In an embodiment of the disclosure, determining to monitor the reference signal set corresponding to the indication information based on the indication information, includes determining to monitor the reference signal set corresponding to the indication information based on at least one of a serving cell, a bandwidth part, a cell physical layer identity and a transmission and reception point corresponding to the indication information.

In an embodiment of the disclosure, the second reference signal set is determined based on the first reference signal set.

In an embodiment of the disclosure, the second reference signal set corresponds to the first reference signal set one by one.

In an embodiment of the disclosure, a method performed by a base station is proposed, which includes transmitting configuration information to a user equipment; and transmitting indication information to the user equipment; wherein the indication information is used by the user equipment to determine whether to monitor a reference signal set related to beam failure.

In an embodiment of the disclosure, the indication information is further used for the user equipment to determine whether to monitor the reference signal set related to beam failure on a first time domain resource; wherein the first time domain resource is determined based on at least one of: starting and/or ending of the first time domain resource is determined by the indication information; a time domain position of the first time domain resource is determined by a time domain position of a channel or signal carrying the indication information.

In an embodiment of the disclosure, the indication information is further used for the user equipment to determine whether to monitor the reference signal set related to beam failure based on at least one of a serving cell, a bandwidth part, a cell physical layer identity and a transmission and reception point corresponding to the indication information.

In an embodiment of the disclosure, a method performed by a base station is proposed, which includes transmitting configuration information to a user equipment; and transmitting indication information to the user equipment; wherein the indication information is used for the user equipment to determine to monitor one of a first reference signal set and a second reference signal set.

In an embodiment of the disclosure, the indication information is further used by the user equipment to determine to monitor one of the first reference signal set and the second reference signal set on a second time domain resource; wherein the second time domain resource is determined based on at least one of: starting and/or ending of the second time domain resource is determined by the indication information; the time domain position of the second time domain resource is determined by a time domain position of a channel or signal carrying the indication information.

In an embodiment of the disclosure, the indication information is further used for the UE to determine to monitor one of the first reference signal set and the second reference signal set based on at least one of a serving cell, a bandwidth part, a cell physical layer identity and a transmission and reception point corresponding to the indication information.

In an embodiment of the disclosure, the second reference signal set is determined based on the first reference signal set.

In an embodiment of the disclosure, the second reference signal set corresponds to the first reference signal set one by one.

In an embodiment of the disclosure, a user equipment (UE) is provided, including a transceiver; and a processor coupled to the transceiver and configured to perform the methods disclosed in embodiments herein.

In an embodiment of the disclosure, a base station includes a transceiver; and a processor coupled to the transceiver and configured to perform the methods disclosed herein.

### Advantageous Effects of Invention

The disclosure provides a method and a device for receiving and transmitting information, which can improve the receiving performance of a terminal device. More specifically, the method provided by the disclosure can improve the performance of the terminal device in beam failure detection and ensure the reliability of the terminal device; in addition, the method can also reduce the energy consumption of the terminal device by reducing measurement of reference signals. In addition, in the disclosure, a method for the terminal device to perform beam failure detection in a scenario of a base station energy-saving mode is provided, so that after reception of indication from the base station, the terminal device can adjust the reference signals used for beam failure detection accordingly, and determine whether to monitor these reference signals.

The disclosure also provides a corresponding method, so that the terminal device can flexibly change the detection behavior and subsequent recovery behavior for candidate beam reference signals. In addition, the feasible method that the base station provides the energy-saving indication of the base station to the terminal device makes the terminal device know the granularity of the base station in time domain, frequency domain and space domain, thus improving the performance of beam failure detection.

### BRIEF DESCRIPTION OF DRAWINGS

The above and other features, aspects and advantages of the disclosure will be clearer according to the following description taken in conjunction with the accompanying drawings.

FIG. 1 illustrates an example wireless network according to various embodiments of the disclosure;

FIG. 2a illustrates an example wireless transmission path according to the disclosure;

FIG. 2b illustrates an example wireless reception path according to the disclosure;

FIG. 3a illustrates the structure of a user equipment (UE) in a wireless communication network according to various embodiments of the disclosure;

FIG. 3b illustrates the structure of a base station in a wireless communication network according to various embodiments of the disclosure;

FIG. 4 illustrates a method 400 performed by a user equipment (UE) according to various embodiments of the disclosure;

FIG. 5 illustrates another method 500 performed by a user equipment (UE) according to various embodiments of the disclosure;

FIG. 6 illustrates a method 600 performed by a base station according to various embodiments of the disclosure;

FIG. 7 illustrates another method 700 performed by a base station according to various embodiments of the disclosure;

FIG. 8 illustrates a user equipment (UE) 800 according to various embodiments of the disclosure; and

FIG. 9 illustrates a base station 900 according to various embodiments of the disclosure.

### MODE FOR THE INVENTION

Hereinafter, embodiments of the disclosure will be described in detail with reference to the accompanying drawings. It should be noted that in the drawings, the same or similar elements are denoted by the same or similar reference numerals as much as possible. In addition, detailed descriptions of known functions or configurations that may obscure the subject matter of the disclosure will be omitted.

When describing the embodiments of the disclosure, the description related to the technical contents known in the art and not directly related to the disclosure will be omitted. Such unnecessary descriptions are omitted to prevent obscuring the main idea of this disclosure and to convey the main idea more clearly.

For the same reason, some elements may be enlarged, omitted or shown schematically in the drawings. In addition, the size of each component does not fully reflect the actual size. In the drawings, the same or corresponding elements have the same reference numerals.

The advantages and features of the disclosure and the way to realize them will become clear by referring to the embodiments described in detail below in conjunction with the accompanying drawings. However, the disclosure is not limited to the embodiments set forth below, but can be implemented in various forms. The following examples are provided only to fully disclose this disclosure and inform those skilled in the art of the scope of this disclosure, and this disclosure is only limited by the scope of the appended claims. Throughout the specification, the same or similar reference numerals refer to the same or similar elements.

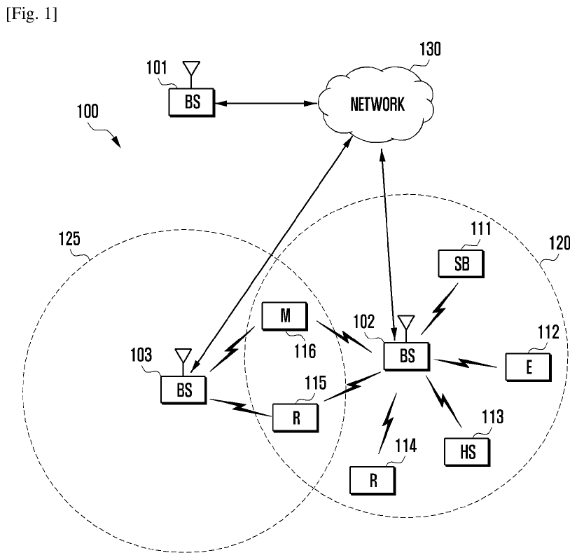

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

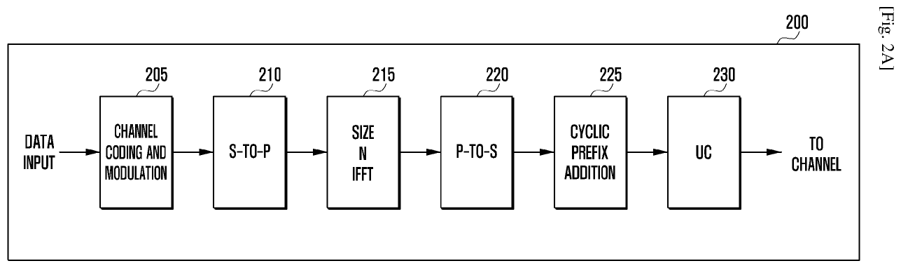

FIGS. 2a and 2b illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

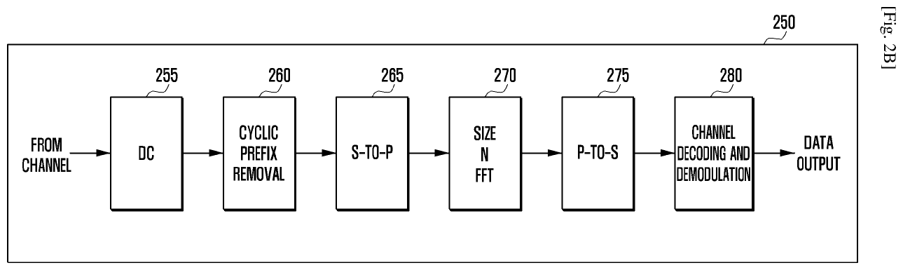

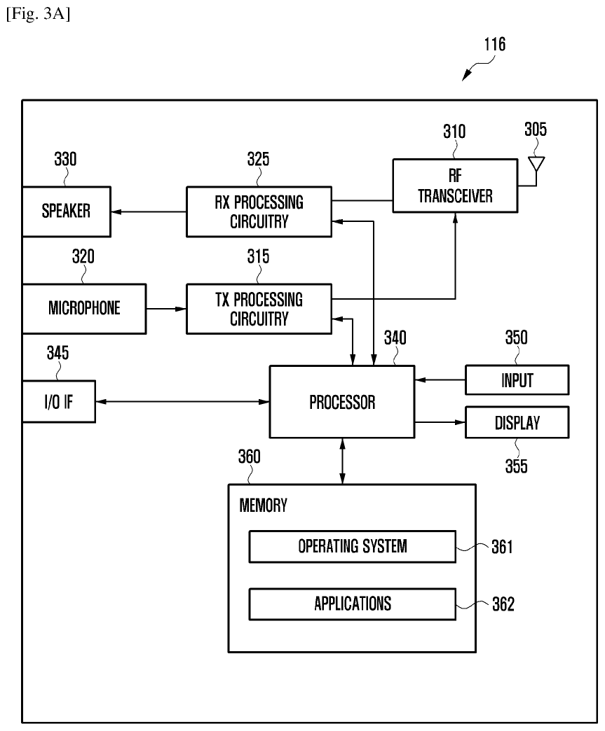

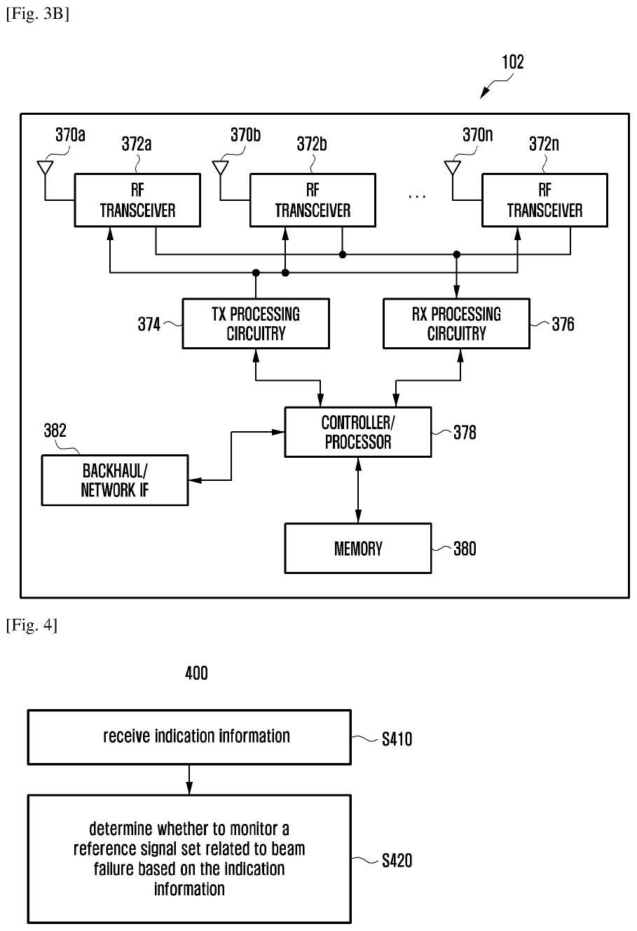

FIG. 3a illustrates an example UE 116 according to the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactivated video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and perform an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to perform the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactivated video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to perform the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In actual deployment, the high power consumption of a NR base station greatly increases the operating cost of a operator, the main reason is that the NR base station integrates a large number of advanced functions, such as fine granularity of time domain scheduling, fine granularity of frequency domain scheduling and fine granularity of space domain scheduling. These functions have greatly improved user experience, but correspondingly brought great power consumption. Especially, when the number of users served by the base station is small, the existing mechanism does not enable the base station flexibly adjust its scheduling mode. Here, the main limitation is that when the base station dynamically adjusts the scheduling granularity (time domain/frequency domain/space domain), a terminal device cannot correspondingly adjust the reception or transmission assumption, resulting in performance degradation of the terminal device. In order to solve this problem, a feasible method is that the base station provides energy-saving indication of the base station to the terminal device. The base station transmits the indication to the terminal device, so that the terminal device can know the granularity of the base station in time domain, frequency domain and space domain. In the disclosure, a method for the terminal device to perform beam failure detection in the scenario of a base station energy-saving mode is provided. After reception of the indication from the base station, the terminal device can adjust reference signals for beam failure detection accordingly, and determine whether to monitor these reference signals. Therefore, the method provided by the disclosure can improve the performance of the terminal device in beam failure detection, thereby ensuring the reliability of the terminal device; in addition, this method can also reduce the energy consumption of the terminal device by reducing the measurement of reference signals.

The disclosure will be described in detail below with reference to specific embodiments.

### Embodiment 1

A user equipment (UE) receives indication information from a base station; and determines whether to monitor a reference signal set based on the indication information.

Optionally, determining whether to monitor the reference signal set can be understood as determining to monitor the reference signal set; or understood as determining not to monitor (not expected to monitor) the reference signal set.

Optionally, the purpose for which the terminal device monitors the reference signal set is radio link quality detection (or assess of radio link quality); or, the terminal device determines whether to assess the radio link quality according to the reference signal set.

Optionally, the purpose for which the terminal device monitors the reference signal set is beam failure detection; that is, the terminal device performs beam failure detection according to the reference signal set. Optionally, reference signals in the reference signal set are used for beam failure detection. This reference signal set is called q₀, q_{0,0} or q_{0,1}.

There are two methods to determine q₀:

### Method 1 (Explicit)

A terminal receives configuration information from a base station; the terminal device (on a bandwidth part (BWP) of a serving cell) determines q₀ according to the indication of a reference signal indicated by the corresponding configuration information (for example, RRC signaling, failureDetectionResourcesToAddModList). Specifically, q₀ is determined according to the reference signal in the RRC signaling for purpose of beam failure detection.

### Method 2 (Implicit)

A terminal device receives configuration information from a base station; the terminal device determines q₀ on a bandwidth part (BWP) of a serving cell according to a reference signal corresponding to a TCI state without the indication of the above configuration information; the TCI state refers to the TCI state of a CORESET used by the terminal device to monitor PDCCH.

There are two methods to determine q_{0,0}:

### Method 1 (Explicit)

A terminal device receives indication information from a base station; the terminal device determines q_{0,0} according to the indication information (e.g., MAC CE).

### Method 2 (Implicit)

q_{0,0} is determined according to CORESETPoolIndex. Optionally, q_{0,0} is determined according to the reference signal of the TCI state of CORESET with CORESETPoolIndex of 0 or without configured CORESETPoolIndex.

There are two methods to determine q_{0,1}:

### Method 1 (Explicit)

q_{0,1} is indicated according to explicit signaling (e.g., MAC CE).

### Method 2 (Implicit)

q_{0,1} is determined according to CORESETPoolIndex. Optionally, q_{0,1} is determined according to the reference signal of the TCI state of the CORESET with CORESETPoolIndex of 1.

The following methods can help the terminal device determine whether to monitor the reference signal set (q₀, q_{0,0} or q_{0,1}) on a first time domain resource.

Optionally, the above indication information is related to network energy-saving. Optionally, the indication information may be used to inform the terminal device whether the base station device is in a network energy-saving mode on the first time domain resource. If a first information indicates that it is not in the network energy-saving mode, the terminal device monitors the reference signal set on the first time domain resource; if the first information indicates that it is in the network energy-saving mode, the terminal device does not monitor (is not expected to detect) the reference signal set on the first time domain resource.

Optionally, the above indication information may be UE-specific information, group-common information or cell-common information.

In the following examples, taking the purpose for the terminal device to monitor the reference signal is beam failure detection as an example. The terminal device determining whether to monitor the reference signal set is understood as the terminal device determining it is not expected to perform beam failure detection according to the reference signal set on the first time domain resource. Taking the first information as an example of the indication information.

### Example 1 (Time Domain Resource)

### Method 1

The first time domain resource is determined according to the first information. That is, the terminal device determines a time domain resource (a time period, that is, the starting and ending of the time domain resource) according to the first information. The terminal is not expected to perform beam failure detection in this time period. In other words, the terminal device is not expected to perform beam failure detection according to (q₀ or q_{0,0} and q_{0,1}) in this time period. The time unit of the time period can be at least one of a frame, a subframe, a slot, a sub-slot, a symbol, etc. Among them, the subcarrier spacing (SCS) corresponding to the slot, sub-slot and symbol can be determined according to at least one of the followings:
reference subcarrier spacing. For example, reference subcarrier spacing indication (referenceSubcarrierSpacing) in TDD configuration information (tdd-UL-DL-ConfigurationCommon). Furthermore, the TDD configuration information is for the PCell of the terminal device.

subcarrier spacing of an SSB; further, it is the subcarrier spacing of the SSB corresponding to the latest PRACH transmission of the terminal device; another example is the SSB corresponding to a TCI state of CORESET#0 indicated by the base station through MAC-CE signaling.
preset subcarrier spacing, for example, 15 kHz, 30 kHz, 60 kHz, 120 kHz, 240 kHz.
subcarrier spacing related to a frequency range; furthermore, the subcarrier spacing for different frequency ranges can be configured (defined) separately, wherein these frequency ranges include FR1, FR2 (FR2-1, FR2-2, refer to existing protocols for specific meanings). For example, subcarrier spacing is 15 kHz for FR1; and subcarrier spacing is 60 kHz for FR2.
subcarrier spacing corresponding to CORESET#0 of the terminal device.
subcarrier spacing corresponding to the initial BWP of the terminal device. For example, subCarrierSpacingCommon in MIB.

Advantageous effects: according to the above method, it can be determined in which time period the terminal device is not required (or is required) to monitor the reference signal set for beam failure detection. The terminal can save energy if the terminal does not monitor the reference signal set in the corresponding time period.

### Method 2

A time domain position of the first time domain resource is determined by a time domain position of the channel or signal carrying the indication information. Optionally, the time domain position of the first time domain resource is before the channel or signal carrying the indication information. Optionally, the time domain position of the first time domain resource overlaps with the channel or signal carrying the indication information. Optionally, the first time domain resource information refers to the time domain resource after the reception or transmission of the channel or signal related to the first information, taking this as an example. The terminal device is not expected to perform beam failure detection after transmission or reception of the channel or signal related to the first information. In other words, the terminal device is not expected to perform beam failure detection (according to q₀ or q_{0,0} and q_{0,1}) after transmission or reception of the channel or signal related to the first information. For example, the first time domain resource is the time domain resource after reception of the channel or signal (PDCCH, PDSCH, etc.) related to the first information. For another example, the first time domain resource is the time domain resource after reception of the channel or signal (PUCCH or PUSCH) carrying feedback information (HARQ-ACK information) for the channel or signal (PDSCH, etc.) related to the first information. For another example, the first time domain resource is the time domain resource after a time period after reception of the channel or signal (PDCCH, PDSCH, etc.) related to the first information. For another example, the first time domain resource is the time domain resource after a time period after reception of the channel or signal (PUCCH or PUSCH) carrying the feedback information (HARQ-ACK information) for the channel or signal (PDSCH, etc.) related to the first information. Optionally, the time period is the time for the terminal device to process (decode) the first information. Optionally, the time unit corresponding to the time period may be as described with reference to the above examples.

Advantageous effects: According to the above method, it can be determined from which time point the terminal device is not required (or is required) to monitor the reference signal set for beam failure detection. The terminal can save energy if the terminal does not monitor the reference signal set from the corresponding time point.

### Embodiment 2

A user equipment receives indication information from a base station; and determines whether to monitor a reference signal set based on the indication information.

Optionally, determining whether to monitor the reference signal set can be understood as determining to monitor the reference signal set; or understood as determining not to monitor (not expected to detect) the reference signal set.

Optionally, the terminal device monitors the reference signal set for the purpose of radio link quality detection (or assess of radio link quality); that is, the terminal device determines whether to assess the radio link quality according to the reference signal set.

Optionally, the terminal device monitors the reference signal set for the purpose of beam failure detection; that is, the terminal device performs beam failure detection according to the reference signal set. Optionally, reference signals in the reference signal set are used for beam failure detection. The reference signal set is called q₀, q_{0,0} or q_{0,1}. Refer to Embodiment 1 for the determination methods for q₀, q_{0,0} or q_{0,1}.

The following methods can help the terminal device determine whether to monitor the reference signal set (q₀, q_{0,0} or q_{0,1}) corresponding to the indication information based on at least one of a serving cell, a bandwidth part, a cell physical layer identity and a transmission and reception point corresponding to the indication information.

Optionally, the above indication information is related to network energy-saving. Specifically, the indication information may be used to inform the terminal device whether the base station device is in a network energy-saving mode on at least one of the serving cell, the bandwidth part, the cell physical layer identity and the transmission and reception point indicated by the indication information. If a first information indicates that it is not in the network energy-saving mode, the terminal device monitors the reference signal set on the corresponding serving cell, bandwidth part, cell physical layer identity and transmission and reception point; if the first information indicates that it is in the network energy-saving mode, the terminal device does not monitor the reference signal set on the corresponding serving cell, bandwidth part, cell physical layer identity and transmission and reception point.

Optionally, the above indication information may be UE-specific information, group-common information or cell-common information.

In the following examples, the terminal device monitors the reference signal for the purpose of beam failure detection. The terminal device determining whether to monitor the reference signal set is understood as the terminal device determining that it is not expected to perform beam failure detection according to the reference signal set on a first time domain resource. Taking the first information as an example of the indication information.

### Example 1 (Serving Cell)

The first information is related to the serving cell. Specifically, the first information is related to the serving cell in the following methods:

### Method 1

The first information corresponds to a SCell. Specifically, according to the first information, the terminal device is not expected to perform beam failure detection in the SCell (for example, all SCells) (according to q₀, q_{0,0} Or q_{0,1}). In other words, the terminal device is not expected to perform beam failure detection in the activated BWP (DL BWP) corresponding to the SCell (for example, all SCells) (according to q₀, q_{0,0} or q_{0,1}).

Advantageous effects: according to the above method, it can be determined that the terminal device is not required (or is required) to monitor the reference signal set for beam failure detection in the SCell. The terminal can save energy if the terminal does not monitor the reference signal set in the SCell.

### Method 2

The device determines a serving cell ID according to the first information (for example, the first information includes one or more serving cell IDs). Specifically, according to the first information, the terminal device is not expected to perform beam failure detection in the serving cell indicated by the first information (the serving cell of which the serving cell ID is equal to the serving cell ID indicated by the first information). In other words, the terminal device is not expected to perform beam failure detection in the serving cell in the network energy-saving. Or, the terminal device is not expected to perform beam failure detection in the activated BWP (DL BWP) corresponding to the serving cell indicated by the first information.

Advantageous effects: according to the above method, it can be determined that the terminal device is not required (or is required) to monitor the reference signal set for beam failure detection in the cells indicated by the base station. The terminal can save energy if the terminal does not monitor the reference signal set in these serving cells.

### Method 3

The first information corresponds to a SCell (secondary cell) ID. Specifically, the terminal device is not expected to perform beam failure detection in the SCell indicated by the first information. Or, the terminal device is not expected to perform beam failure detection on the activated BWP (DL BWP) corresponding to the SCell indicated by the first information.

### Example 2 (BWP)

The first information is related to a BWP. Specifically, the first information is related to the BWP in the following methods:

### Method 1

The first information indicates BWP information (BWP ID), which corresponds to a PCell. Specifically, the terminal device is not expected to perform beam failure detection on the BWP indicated by the first information in the PCell (the ID of the BWP activated in the PCell is the same as the BWP ID indicated by the first information) (according to q₀ or q_{0,0} and q_{0,1}).

### Method 2

The first information indicates serving cell information (serving cell ID or SCell ID) and corresponding BWP information (BWP ID). Specifically, the terminal device is not expected to perform beam failure detection on the corresponding BWP in the serving cell indicated by the first information (the ID of the corresponding activated BWP ID is the same as that indicated by the first information) (according to q₀ or q_{0,0} and q_{0,1}).

Optionally, in the above method, the terminal device being not expected to perform beam failure detection on a BWP can be further understood as the terminal device being not expected to perform beam failure detection on the BWP and/or the terminal device being not expected to perform beam failure detection on a resource implicitly configured for the BWP.

Advantageous effects: according to the above methods, it can be determined that the terminal device is not required (or is required) to monitor the reference signal set for beam failure detection on the BWPs corresponding to the indication of the base station. The terminal can save energy if the terminal does not monitor the reference signal set in these BWPs.

### Example 3 (Physical Cell Identifier, PCI)

The first information is related to a PCI. Specifically, the first information indicates PCI information (one or more PCIs). Specifically, the terminal device is not expected to perform (beam failure) detection on an SSB corresponding to the above PCI information. Or, the terminal device is not expected to perform beam failure detection on the reference signal set (q_{0,0} or q_{0,1}) corresponding to the PCI information.

Optionally, the reference signal set includes the SSB related to the PCI information.

Optionally, the above PCI is different from phySCellId in ServingCellConfigCommon.

Advantageous effects: according to the above method, it can be determined that the terminal device is not required (or is required) to monitor the reference signal set for beam failure detection on the PCIs corresponding to the indication of the base station. The terminal device can save energy if the terminal does not monitor the reference signal set corresponding to these PCIs.

### Example 4 (Transmission and Reception Point (TRP))

The first information is used to indicate whether the terminal device performs beam failure detection according to the reference signal set (q_{0,0} and/or q_{0,1}). Optionally, this information is a TRP switching indication. The specific methods are as follows:

Method 1 (Switching q_{0,1})

According to the first information, the terminal device determines whether it is expected to monitor q_{0,1}. Specifically, the first information includes one information bit.

When the information bit is 0/1, the terminal device monitors q_{0,1}; when the information bit is 1/0, the terminal device is not expected to monitor q_{0,1}.

Method 2 (Switching q_{0,0} and q_{0,1} Respectively)

According to the first information, the terminal determines whether it is expected to monitor q_{0,0} and q_{0,1}, respectively. Specifically, the first information includes two information bits.

When the first information bit is 0/1, the terminal device monitors q_{0,0}; when the first information bit is 1/0, the terminal device is not expected to monitor q_{0,0}.

When the second information bit is 0/1, the terminal device monitors q_{0,1}; when the second information bit is 1/0, the terminal device is not expected to monitor q_{0,1}.

Optionally, in the above methods, the cell or the serving cell is activated (not deactivated).

In this embodiment, the terminal device being not expected to perform beam failure detection in a cell according to q₀ or q_{0,0} and q_{0,1} can be equivalently understood as the terminal device being not expected to perform beam failure detection in a cell, and is not expected to perform beam failure detection on a resource implicitly configured for that cell.

In addition, it should be noted that different examples in the above embodiments can be combined arbitrarily.

In addition, it should be noted that the above different embodiments can be combined arbitrarily. For example, Embodiment 1 and Embodiment 2 can be combined, that is, based on the indication information, determining whether to assess the radio link quality according to the reference signal set on the first time domain resource, comprises: determining the first time domain resource based on the indication information; and determining whether to assess the radio link quality according to the reference signal set on the first time domain resource, based on at least one of the serving cell, the bandwidth part, the cell physical layer identity and the transmission and reception point corresponding to the indication information.

### Embodiment 3

A user equipment receives indication information from a base station; and determine to monitor one of a first reference signal set and a second reference signal set based on the indication information.

Optionally, determining to monitor one of the first reference signal set and the second reference signal set can be understood as determining to monitor the first reference signal set; or understood as determining to monitor the second reference signal set.

Optionally, the terminal device monitors the first reference signal set (or the second reference signal set) for the purpose of radio link quality detection (or assess of radio link quality); that is, the terminal device determines to assess the radio link quality according to the first reference signal set (or the second reference signal set).

Optionally, the terminal device monitors the first reference signal set (or the second reference signal set) for the purpose of beam failure detection; that is, the terminal device performs beam failure detection according to the first reference signal set (or the second reference signal set).

Optionally, reference signals in the first reference signal set are used for beam failure detection. The reference signal set is called q₀, q_{0,0} or q_{0,1}. Refer to Embodiment 1 for the determination methods for q₀, q_{0,0} or q_{0,1}.

Optionally, reference signals in the second reference signal set are used for beam failure detection. The reference signal set is called q_{0,PS}, q_{0,0,PS} or q_{0,1,PS}. The determination methods for the reference signal set are as follows:

### Method 1

The reference signal set is indicated by the base station. For example, an explicit indication (RRC, MAC-CE or DCI signaling). Specifically, the base station indicates a reference signal ID corresponding to the reference signal set.

### Method 2

The reference signal set is determined according to the first reference signal set.

### Method 3

The reference signal set is determined according to the reference signal corresponding to a TCI state of CORESET. Specifically, the CORESET is used for the terminal device to monitor a PDCCH.

Advantageous effects: according to the above methods, the second reference signal set (corresponding reference signals) can be determined. Compared with the first reference signal set, the second reference signal set may correspond to fewer reference signal resources, or the second reference signal set may have wider (or fewer) beams than the reference signals corresponding to the first reference signal set, so that the network device can transmit fewer reference signals for energy-saving. Correspondingly, the terminal device can monitor the reference signals accordingly to ensure the accuracy of beam failure detection.

The above method 2, that is, the second reference signal set being determined according to the first reference signal set has further implementations. In these implementations, the terminal device receives second information:

### Implementation 1

The second information corresponds to (or includes) an indication of a first reference signal (e.g., SSB ID, CSI-RS ID). The second reference signal set is determined according to the reference signals in the first reference signal set that are different from (or the same as) the first reference signal.

### Implementation 2

The second information corresponds to (or includes) an indication of a first reference signal (e.g., SSB ID, CSI-RS ID). The second reference signal set is determined according to the reference signals in the first reference signal set that are not quasi-co-located (or quasi-co-located, QCLed) with the first reference signal.

### Implementation 3

The second information corresponds to (or includes) an indication of a first reference signal type (e.g., SSB, CSI-RS). The second reference signal set is determined according to the reference signals in the first reference signal set that are different from (or the same as) the first reference signal in type.

### Implementation 4

The second information corresponds to (or includes) an indication related to a SFN (for example, switching indication of the SFN). According to the indication information, the second reference signal set is determined according to the first reference signal set, and if the first reference signal set is related to CORESET corresponding to two activated TCI states, the second reference signal set is related to one of the two TCI states optional, the first TCI state of the two TCI states. Or, the second reference signal set does not include the reference signals corresponding to one of the two TCI states, more specifically, the second reference signal set does not include the reference signals corresponding to the second TCI state of the two TCI states.

Optionally, the second reference signal set corresponds to the first reference signal set one by one. For example, q₀ corresponds to q_{0,PS}; q_{0,0} corresponds to q_{0,0,PS}; q_{0,1} corresponds to q_{0,1,PS}. The specific methods are as follows:

### Method 1

The first reference signal set corresponds to the same BWP and/or serving cell as the second reference signal set.

### Method 2

The first reference signal set and the second reference signal set correspond to a same PCI.

### Method 3

The first reference signal set corresponds to the same CORESETPoolIndex as the second reference signal set. Specifically, these two reference signal sets are both determined according to the TCI state of the CORESET related to CORESETPoolIndex=1; or, the two reference signal sets are both determined according to the TCI state of the CORESET related to CORESETPoolIndex=0 (without configured CORESETPoolIndex).

### Method 4

The first reference signal set corresponds to the same candidate beam reference signals as the second reference signal set (e.g., candidateBeamRSList, candidateBeamRSList1, candidateBeamRSList2).

The following methods can help the terminal device determine to monitor one of the first reference signal set (q₀, q_{0,0} or q_{0,1}) and the second reference signal set (q_{0,PS}, q_{0,0,PS} or q_{0,1,PS}) on the first time domain resource.

Advantageous effects: according to the above methods, (the reference signals corresponding to) the second reference signal set can be determined through the first reference signal set. The advantage of these method is that the second reference signal set is indicated by implicit indication, which saves signaling overhead.

Optionally, the above indication information is related to network energy-saving. Specifically, the indication information may be used to inform the terminal device whether the base station device is in a network energy-saving mode on the first time domain resource. If a first information indicates that it is not in the network energy-saving mode, the terminal device monitors the first reference signal set on the first time domain resource; if the first information indicates that it is in the network energy-saving mode, the terminal device monitors the second reference signal set on the first time domain resource.

Optionally, the above indication information may be UE-specific information, group-common information or cell-common information.

In the following examples, taking the terminal device monitoring the reference signals for the purpose of radio link quality assess as an example. The terminal determining to monitor one of the first reference signal set and the second reference signal set is understood as the terminal determining to monitor one of the first reference signal set and the second reference signal set on the first time domain resource. Taking the first information as an example of the indication information. Taking the first reference signal set being q₀ and the second reference signal set being q_{0,PS} as an example.

### Example 1 (Time Domain Resource)

### Method 1

The first time domain resource is determined according to the first information. That is, the terminal device determines a time domain resource (a time period, that is, the starting and ending of the time domain resource) according to the first information. The terminal assesses radio link quality during this time period. Further, the terminal device assesses the radio link quality according to (q_{0,PS}) during this time period. Optionally, the terminal device also determines whether to use q₀ or q_{0,PS} to assess the radio link quality according to the first information. For example, the time information indicated by the first information is time period #1, and the information further includes one information bit. When the bit is 0, the terminal device assesses the radio link quality according to q₀ during time period #1; when the bit is 1, the terminal device assesses the radio link quality according to q_{0,PS} during time period #1. In addition, the description of the unit of the first time domain resource refers to Embodiment 1.

### Method 2

A time domain position of the first time domain resource is determined by a time domain position of the channel or signal carrying the indication information. Optionally, the time domain position of the first time domain resource is before the channel or signal carrying the indication information; optionally, the time domain position of the first time domain resource overlaps with the channel or signal carrying the indication information; optionally, the first time domain resource information refers to the time domain resource after transmission or reception of the channel or signal related to the first information, taking this as an example. The terminal assesses the radio link quality after transmission or reception of the channel or signal related to the first information. Further, the terminal device assesses the radio link quality according to q_{0,PS} after transmission or reception of the channel or signal related to the first information. Optionally, the terminal device also determines whether to use q₀ or q _{0,PS} to assess the radio link quality according to the first information. For example, the first information includes one information bit, and when the bit is 0, the terminal device assesses the radio link quality according to q₀ on a first resource; when the bit is 1, the terminal device assesses the radio link quality according to q_{0,PS} on the first resource.

Further, the first time domain resource is the time domain resource after reception of the channel or signal (PDCCH, PDSCH, etc.) related to the first information. For another example, the first time domain resource is the time domain resource after reception of the channel or signal (PUCCH or PUSCH) carrying feedback information (HARQ-ACK information) for the channel or signal (PDSCH, etc.) related to the first information. For another example, the first time domain resource is the time domain resource after a time period after reception of the channel or signal (PDCCH, PDSCH, etc.) related to the first information. For another example, the first time domain resource is the time domain resource after a time period after reception of the channel or signal (PUCCH or PUSCH) carrying the feedback information (HARQ-ACK information) for the channel or signal (PDSCH, etc.) related to the first information. Optionally, the time period is the time for the terminal device to process (interpret) the first information. Optionally, the time unit corresponding to the time period is as described with reference to the above examples.

### Embodiment 4

A user equipment receives indication information from a base station; and determines to monitor one of a first reference signal set and a second reference signal set based on the indication information.

Optionally, determining to monitor one of the first reference signal set and the second reference signal set can be understood as determining to monitor the first reference signal set; or understood as determining to monitor the second reference signal set.

Optionally, the terminal device monitors the first reference signal set (or the second reference signal set) for the purpose of radio link quality detection (or assess of radio link quality); that is, the terminal device determines to assess the radio link quality according to the first reference signal set (or the second reference signal set).

Optionally, the terminal device monitors the first reference signal set (or the second reference signal set) for the purpose of beam failure detection; that is, the terminal device performs beam failure detection according to the first reference signal set (or the second reference signal set).

Optionally, reference signals in the first reference signal set are used for beam failure detection. The reference signal set is called q₀, q_{0,0} or q_{0,1}. Refer to Embodiment 1 for the determination methods for q₀, q_{0,0} or q_{0,1}.

Optionally, reference signals in the second reference signal set is used for beam failure detection. The reference signal set is called q_{0,PS}, q_{0,0,PS} or q_{0,1,PS}. Determination methods for the reference signal set is as follows:

### Method 1

The reference signal set is indicated by the base station. For example, an explicit indication (RRC, MAC-CE or DCI signaling). Specifically, the base station indicates a reference signal ID corresponding to the reference signal set.

### Method 2

The reference signal set is determined according to the first reference signal set.

### Method 3

The reference signal set is determined according to the reference signal corresponding to a TCI state of CORESET. Specifically, the CORESET is used for the terminal device to monitor a PDCCH.

Advantageous effects: according to the above methods, the second reference signal set (corresponding reference signals) can be determined. Compared with the first reference signal set, the second reference signal set may correspond to fewer reference signal resources, or the second reference signal set may have wider (or fewer) beams than the reference signals corresponding to the first reference signal set, so that the network device can transmit fewer reference signals for energy-saving. Correspondingly, the terminal device can monitor the reference signals accordingly to ensure the accuracy of beam failure detection.

The above method 2, that is, the second reference signal set being determined according to the first reference signal set has further implementations. In these implementations, the terminal device receives second information:

### Implementation 1

The second information corresponds to (or includes) an indication of a first reference signal (e.g., SSB ID, CSI-RS ID). The second reference signal set is determined according to the reference signals in the first reference signal set that are different from (or the same as) the first reference signal.

### Implementation 2

The second information corresponds to (or includes) an indication of a first reference signal (e.g., SSB ID, CSI-RS ID). The second reference signal set is determined according to the reference signals in the first reference signal set that are not quasi-co-located (or quasi-co-located, QCLed) with the first reference signal.

### Implementation 3

The second information corresponds to (or includes) an indication of a first reference signal type (e.g., SSB, CSI-RS). The second reference signal set is determined according to the reference signals in the first reference signal set that are different from (or the same as) the first reference signal in type.

### Implementation 4

The second information corresponds to (or includes) an indication related to a SFN (for example, switching indication of the SFN). According to the indication information, the second reference signal set is determined according to the first reference signal set, and if the first reference signal set is related to CORESET corresponding to two activated TCI states, the second reference signal set is related to one of the two TCI states, more specifically, the first TCI state of the two TCI states. Or, the second reference signal set does not include the reference signals corresponding to one of the two TCI states, more specifically, the second reference signal set does not include the reference signals corresponding to the second TCI state of the two TCI states.

Optionally, the second reference signal set corresponds to the first reference signal set one by one. For example, q₀ corresponds to q_{0,PS}; q_{0,0} corresponds to q_{0,0,PS}; q_{0,1} corresponds to q_{0,1,PS}. The specific methods are as follows:

### Method 1

The first reference signal set corresponds to the same BWP and/or serving cell as the second reference signal set.

### Method 2

The first reference signal set and the second reference signal set correspond to a same PCI.

### Method 3

The first reference signal set corresponds to the same CORESETPoolIndex as the second reference signal set. Specifically, these two reference signal sets are both determined according to the TCI state of the CORESET related to CORESETPoolIndex=1; or, the two reference signal sets are both determined according to the TCI state of the CORESET related to CORESETPoolIndex=0 (without configured CORESETPoolIndex).

### Method 4

The first reference signal set corresponds to the same candidate beam reference signals as the second reference signal set (e.g., candidateBeamRSList, candidateBeamRSList1, candidateBeamRSList2).

The following methods can help the terminal device determine to monitor one of the first reference signal set (q₀, q_{0,0} Or q_{0,1}) and the second reference signal set (q_{0,PS}, q_{0,0,PS} or q_{0,1,PS}) based on at least one of a serving cell, a bandwidth part, a cell physical layer identity and a transmission and reception point corresponding to the indication information.

Advantageous effects: according to the above methods, (the reference signals corresponding to) the second reference signal set can be determined through the first reference signal set. The advantage of these method is that the second reference signal set is indicated by implicit indication, which saves signaling overhead.

Optionally, the above indication information is related to network energy-saving. Specifically, the indication information may be used to inform the terminal device whether the base station device is in a network energy-saving mode on at least one of the serving cell, the bandwidth part, the cell physical layer identity and the transmission and reception point indicated by the indication information. If a first information indicates that it is not in the network energy-saving mode, the terminal device monitors the first reference signal set on the corresponding serving cell, bandwidth part, cell physical layer identity and transmission and reception point; if the first information indicates that it is in the network energy-saving mode, the terminal device monitors the second reference signal set on the corresponding serving cell, bandwidth part, cell physical layer identity and transmission and reception point.

Optionally, the above indication information may be UE-specific information, group-common information or cell-common information.

In the following examples, taking the terminal device monitoring the reference signal for the purpose of radio link quality assess as an example. Taking the first information as an example of the indication information.

### Example 1 (Serving Cell)

The first information is related to the serving cell. Specifically, the first information is related to the serving cell in the following methods:

### Method 1

The first information corresponds to an SCell. Specifically, according to the first information, the terminal device assesses the radio link quality in the SCell (for example, all SCells) according to q_{0,PS}. Optionally, the terminal device also determines whether to use q₀ or q_{0,PS} to assess the radio link quality according to the first information. For example, the first information indicates the SCell by default, and the information further includes one information bit. When the bit is 0, the terminal device assesses the radio link quality according to q₀ in all SCells (on corresponding activated BWP); when the bit is 1, the terminal device assesses the radio link quality according to q_{0,PS} in all SCells (on corresponding activated BWP). For another example, the first information corresponds to the SCell, and the information further includes one information bit. When the bit is 0, the terminal device assesses the radio link quality according to q_{0,0} and q_{0,1} in all SCells (on corresponding activated BWP); when the bit is 1, the terminal device assesses the radio link quality according to q_{0,0,PS} and q_{0,1,PS} in all SCells (on corresponding activated BWP).

### Method 2

The terminal device determines a serving cell ID according to the first information (for example, the first information includes one or more serving cell IDs). Specifically, according to the first information, the terminal device assesses the radio link quality according to q_{0,PS} in the corresponding serving cell. Optionally, the terminal device also determines whether to use q₀ or q_{0,PS} to assess the radio link quality according to the first information. For example, the first information indicates cell#1 and cell#2, and the information further includes one information bit. When the bit is 0, the terminal device assesses the radio link quality according to q₀ in cell#1 and cell#2 (on the corresponding activated BWP); when the bit is 1, the terminal device assesses the radio link quality according to q_{0,PS} in cell#1 and cell#2 (on the corresponding activated BWP). For another example, the first information indicates cell#1 and cell#2, and the information further includes one information bit. When the bit is 0, the terminal device assesses the radio link quality in cell#1 and cell#2 (on the corresponding activated BWP) according to q_{0,0} and q_{0,1}; when the bit is 1, the terminal device assesses the radio link quality in cell#1 and cell#2 (on the corresponding activated BWP) according to q _{0,0,PS} and q_{0,1,PS}.

### Method 3

The first information corresponds to a SCell (secondary cell) ID. The specific method is similar to the second method, by replacing the cell ID with the SCell ID.

### Example 2 (BWP)

The first information is related to a BWP. Specifically, the first information is related to the BWP in the following methods:

### Method 1

The first information indicates BWP information (BWP ID), which corresponds to a PCell. Specifically, the terminal device assesses the radio link quality according to q_{0,PS} in the BWP indicated by the first information in the PCell (the ID of the BWP activated on the PCell is the same as the BWP ID indicated by the first information). Optionally, the terminal device also determines whether to use q₀ or q_{0,PS} to assess the radio link quality according to the first information. For example, the first information indicates BWP#1, and the information further includes one information bit. When the bit is 0 and the activated BWP of the PCell of the terminal device is BWP#1, the terminal device assesses the radio link quality according to q₀ on BWP#1 of the PCell; in the same case, when the bit is 1, the terminal device assesses the radio link quality according to q_{0,PS} on BWP#1 of the PCell. For another example, the first information indicates BWP#1, and the information further includes one information bit. When the bit is 0 and the activated BWP of the PCell of the terminal device is BWP#1, the terminal device assesses the radio link quality according to q_{0,0} and q_{0,1} on BWP#1 of the PCell; in the same case, when the bit is 1, the terminal device assesses the radio link quality according to q_{0,0,PS} and q_{0,1,PS} on BWP#1 of the PCell.

### Method 2

The first information indicates serving cell information (serving cell ID or SCell ID) and corresponding BWP information (BWP ID). Similar to method 1, by replacing the description of the PCell in method 1 with the first information indicating the serving cell.

### Example 3 (PCI)

The first information is related to a PCI. Specifically, the first information indicates PCI information (one or more PCIs). Specifically:

### Method 1

The terminal assesses the radio link quality according to the reference signal set unrelated to PCI information. For example, the PCI is related to q_{0,1} (that is, q_{0,1} includes the SSB of the PCI); the terminal device assesses the radio link quality according to q_{0,0}.

### Method 2

The terminal assesses the radio link quality according to the reference signal set related to PCI information. For example, the PCI is related to q_{0,1} (that is, q_{0,1} includes SSB of the PCI), and the information further includes one information bit. When the bit is 0, the terminal device assesses the radio link quality according to q_{0,1}; when the bit is 1, the terminal device assesses the radio link quality according to q_{0,1,PS}.

Optionally, the above PCI is different from phySCellId in ServingCellConfigCommon.

### Example 4 (TRP)

The first information is used to indicate the terminal device to assess the radio link quality according to one of the first reference signal set (q_{0,0} and/or q_{0,1}) and the first reference signal set (q_{0,0,PS} and/or q_{0,1,PS}). Optionally, this information is a TRP switching indication. The specific methods are as follows:

Method 1 (Selecting q_{0,1} and q_{0,1,PS})

According to the first information, the terminal determines whether to assess the radio link quality according to q_{0,1} or q_{0,1,PS}. Specifically, the first information includes one information bit.

When the information bit is 0/1, the terminal device assesses the radio link quality according to q_{0,1}; when the information bit is 1/0, the terminal device assesses the radio link quality according to q_{0,1,PS}.

Method 2 (Selecting [q_{0,0} and q_{0,0,PS}], [q_{0,1} and q_{0,1,PS}] Respectively)

According to the first information, the terminal determines whether to assess the radio link quality by at least one of according to q_{0,0} or q_{0,0,PS} and according to q_{0,1} or q _{0,1,PS}, respectively. Specifically, the first information includes two information bits.

When the first information bit is 0/1, the terminal device assesses the radio link quality according to q_{0,0}; when the first information bit is 1/0, the terminal device assesses the radio link quality according to q_{0,0,PS}.

When the second information bit is 0/1, the terminal device assesses the radio link quality according to q_{0,1}; when the second information bit is 1/0, the terminal device assesses the radio link quality according to q_{0,1,PS}.

Optionally, in the above methods, the cell or the serving cell is activated (not deactivated).

In addition, it should be noted that different examples in the above embodiments can be combined arbitrarily.

Advantageous effects: according to the above methods, it can be determined that the terminal device performs beam failure detection in the indicated cell/BWP/PCI/TRP according to the second reference signal set. Since the base station will use the second reference signal set to transmit a reference signal to the terminal device in the cell/BWP/PCI/TRP corresponding to the indication information, through the above methods, the terminal device can switch to the second reference signal set accordingly, thereby ensuring the reliability of the beam failure detection of the terminal device.

In addition, it should be noted that the above different embodiments can be combined arbitrarily. For example, Embodiment 3 and Embodiment 4 can be combined, that is, determining to assess radio link quality according to one of the first reference signal set and the second reference signal set on a first time domain resource based on the indication information, comprising: determining the first time domain resource based on the indication information; and determining to assess radio link quality according to one of the first reference signal set and the second reference signal set on the first time domain resource, based on at least one of the serving cell, the bandwidth part, the cell physical layer identity and the transmission and reception point corresponding to the indication information.

The term “reference signal set” used herein can also be broadly understood as “reference signal index set”, that is, “monitoring/according to a reference signal set” described herein can be understood as “monitoring/according to a resource corresponding to a reference signal index set”, “reference signal” can be understood as “reference signal index set” and “reference signals in the reference signal set” can be understood as “indexes in the reference signal index set”. In addition, the reference signals described herein can be understood as SSB or CSI-RS, where CSI-RS can be periodic.

FIG. 4 illustrates a method 400 performed by a user equipment (UE) according to various embodiments of the disclosure. The UE receives indication information from a base station at S410, and determines whether to monitor a reference signal set related to beam failure based on the indication information at S420.

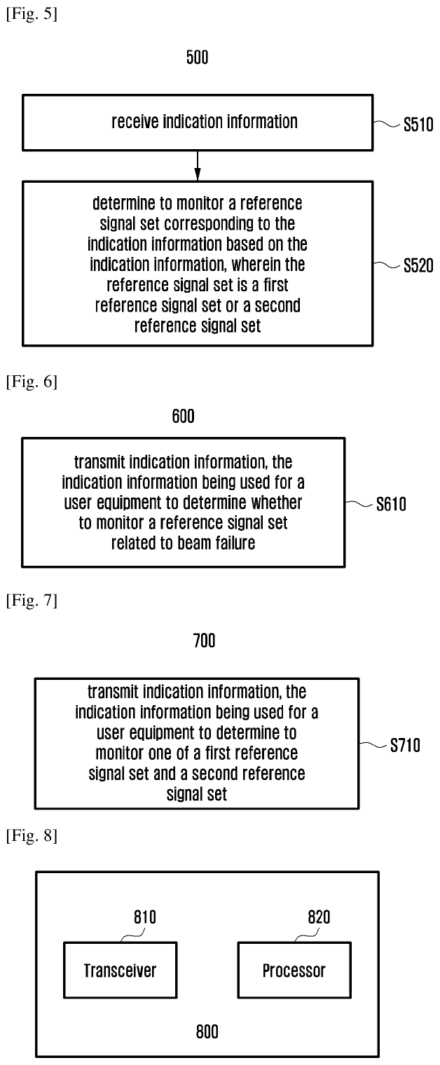

FIG. 5 illustrates another method 500 performed by a UE according to various embodiments of the disclosure. The UE receives indication information from a base station at S510, and determines to monitor a reference signal set corresponding to the indication information based on the indication information at S520, wherein the reference signal set is a first reference signal set or a second reference signal set.

FIG. 6 illustrates a method 600 performed by a base station according to various embodiments of the disclosure. The base station transmits indication information to a UE at S610, the indication information is used for the UE to determine whether to monitor a reference signal set related to beam failure.

FIG. 7 illustrates another method 700 performed by a base station according to various embodiments of the disclosure. The base station transmits indication information to a UE at S710, the indication information is used for the UE to determine to monitor one of a first reference signal set and a second reference signal set.

In addition, for the descriptions of methods 400 and 500 in FIGS. 4 and 5 above, the UE may receive configuration information from the base station; similarly, for the above descriptions of methods 600 and 700 in FIGS. 6 and 7, the base station may transmit configuration information to the UE. Optionally, the configuration information is failure detection resource configuration information (for example, FailureDetectionResourceLoadModlist). Optionally, the configuration information is TCI state configuration information (for example, TCI-State).

FIG. 8 illustrates a user equipment (UE) 800 according to various embodiments of the disclosure. The UE 800 includes a transceiver 810 and a processor 820, wherein the processor 820 is configured to perform the above-mentioned methods disclosed herein that can be performed by the UE.

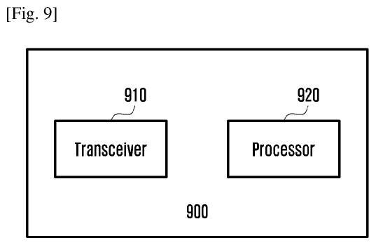

FIG. 9 illustrates a base station 800 according to various embodiments of the disclosure. The base station 800 includes a transceiver 910 and a processor 920, wherein the processor 920 is configured to perform the above-mentioned method disclosed herein that can be performed by the base station.

According to the above description, it can be understood that q_{0,0} and q_{0,1} described herein are independent of each other, and the descriptions of q_{0,0} and q_{0,1} can be equivalently replaced by the descriptions of q₀.

The illustrative logical blocks, modules, and circuits described in this disclosure can be implemented with a general purpose processor, a Digital Signal Processor (DSP), an application specific integrated circuit (application specific integrated circuit), ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure can be embodied directly in hardware, in a software module performed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

In one or more exemplary designs, the functions can be implemented in hardware, software, firmware, or any combination thereof. If implemented in software, each function can be stored on or transmitted by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

With reference to the drawings, the description set forth herein describes example configurations, methods and devices, and does not represent all examples that can be realized or within the scope of the claims. As used herein, the term “example” means “serving as an example, instance or illustration”, not “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains a number of specific implementation details, these should not be construed as limitations on any embodiment or the scope of the claimed protection, but descriptions of specific features of specific embodiments of the disclosure. Some features described in this specification in the context of individual embodiments can also be combined in a single embodiment. On the contrary, various features described in the context of a single embodiment can also be implemented in multiple embodiments alone or in any suitable sub-combination. Furthermore, although features can be described above as functioning in some combinations, and even initially claimed as such, in some cases, one or more features from the claimed combination can be deleted from the combination, and the claimed combination can be aimed at sub-combinations or variations of sub-combinations.

It should be understood that the specific order or hierarchy of steps in the method of the disclosure is an illustration of an exemplary process. Based on the design preference, it can be understood that the specific order or hierarchy of steps in the method can be rearranged to achieve the disclosed functions and effects of the disclosure. The attached method claims present elements of various steps in an example order, and are not meant to be limited to the specific order or hierarchy presented, unless otherwise stated. In addition, although the elements can be described or claimed in the singular form, the plural is also contemplated unless the limitation of the singular is explicitly stated. Therefore, the disclosure is not limited to the illustrated examples, and any device for performing the functions described herein is included in various aspects of the disclosure.

And the text and drawings are only provided as examples to help readers understand this disclosure. They are not intended and should not be construed to limit the scope of the disclosure in any way. Although some embodiments and examples have been provided, based on the disclosure herein, it is obvious to those skilled in the art that changes can be made to the illustrated embodiments and examples without departing from the scope of this disclosure.

1. A method performed by a user equipment (UE), the method comprising:
receiving first indication information from a base station; and
identifying whether to monitor a reference signal set related to beam failure based on the first indication information.

2. The method of claim 1, wherein identifying whether to monitor the reference signal set related to beam failure based on the first indication information comprises:
identifying whether to monitor the reference signal set related to beam failure on a first time domain resource based on the first indication information,
wherein the first time domain resource is identified based on at least one of the following:
starting of the first time domain resource being identified by the first indication information;
ending of the first time domain resource being identified by the first indication information; or
a time domain position of the first time domain resource being identified by a time domain position of a channel or signal carrying the first indication information.

3. The method of claim 1, wherein identifying whether to monitor the reference signal set related to beam failure based on the first indication information comprises:
identifying whether to monitor the reference signal set related to beam failure based on at least one of a serving cell, a bandwidth part, a cell physical layer identity or a transmission and reception point (TRP) corresponding to the first indication information.

4. The method of claim 1, further comprising:
receiving second indication information from the base station; and
identifying to monitor a reference signal set corresponding to the second indication information based on the second indication information,
wherein the reference signal set is a first reference signal set or a second reference signal set.

5. The method of claim 4, wherein identifying to monitor the reference signal set corresponding to the second indication information based on the second indication information comprises:
identifying to monitor the reference signal set corresponding to the second indication information on a second time domain resource based on the second indication information,
wherein the second time domain resource is identified based on at least one of the following:
starting of the second time domain resource being identified by the second indication information;
ending of the second time domain resource being identified by the second indication information; or
a time domain position of the second time domain resource being identified by a time domain position of a channel or signal carrying the second indication information.

6. The method of claim 4, wherein identifying to monitor the reference signal set corresponding to the second indication information based on the indication information comprises:
identifying to monitor the reference signal set corresponding to the second indication information based on at least one of a serving cell, a bandwidth part, a cell physical layer identity or a transmission and reception point (TRP) corresponding to the second indication information.

7. The method of claim 4, wherein the second reference signal set is identified based on the first reference signal set, and
wherein the second reference signal set corresponds to the first reference signal set one by one.

8. A method performed by a base station, the method comprising:
transmitting configuration information to a user equipment; and
transmitting first indication information to the user equipment,
wherein the first indication information is associated with indicating whether to monitor a reference signal set related to beam failure.

9. The method of claim 8, wherein the first indication information is associated with indicating whether to monitor the reference signal set related to beam failure on a first time domain resource,
wherein the first time domain resource is identified based on at least one of:
starting of the first time domain resource being identified by the first indication information;
ending of the first time domain resource being identified by the first indication information; or
a time domain position of the first time domain resource being identified by a time domain position of a channel or signal carrying the first indication information.

10. The method of claim 8, wherein the first indication information is associated with indicating whether to monitor the reference signal set related to beam failure based on at least one of a serving cell, a bandwidth part, a cell physical layer identity, or a transmission and reception point (TRP) corresponding to the first indication information.

11. The method of claim 8, further comprising:
transmitting configuration information to the user equipment;
transmitting second indication information to the user equipment,
wherein the second indication information is associated with indicating the user equipment to identify to monitor one of a first reference signal set and a second reference signal set.

12. The method of claim 11, wherein the second indication information is associated with indicating the user equipment to identify to monitor one of the first reference signal set and the second reference signal set on a second time domain resource,
wherein the second time domain resource is identified based on at least one of the following:
starting of the second time domain resource being identified by the second indication information;
ending of the second time domain resource being identified by the second indication information; or
a time domain position of the second time domain resource being identified by a time domain position of a channel or signal carrying the second indication information.

13. The method of claim 11, wherein the second reference signal set is determined based on the first reference signal set, and
wherein the second reference signal set corresponds to the first reference signal set one by one.

14. A user equipment (UE), comprising:
a transceiver; and
a processor coupled to the transceiver and configured to:
receive first indication information from a base station; and
identify whether to monitor a reference signal set related to beam failure based on the first indication information.

15. A base station comprising:
a transceiver; and
a processor coupled to the transceiver and configured to:
transmit configuration information to a user equipment; and
transmit first indication information to the user equipment,
wherein the first indication information is associated with indicating whether to monitor a reference signal set related to beam failure.
